(19) United States
(12) Patent Application Publication
(10) Pub. No.: US 2005/0174332 A1
(43) Pub. Date: Aug. 11, 2005

(54) Casing having button portion without penetrating interstice

(76) Inventors: Hua-Yu Hunag, Taipei City (TW); Chih-Cheng Liao, Banciao City (TW)

Correspondence Address: BIRCH STEWART KOLASCH & BIRCH, PO BOX 747, FALLS CHURCH, VA, 22040-0747, US

(21) Appl. No.: 10/952,779

(22) Filed: Sep. 30, 2004

(30) Foreign Application Priority Data
Feb. 6, 2004 (TW) 093102868

(51) Int. Cl. G09G 5/00

(52) U.S. Cl. 345/168

(57) ABSTRACT

A casing for an electronic device having a switching unit provided therein includes a button portion embedded in an opening of the casing and facing the switching unit, wherein no penetrating interstice exists at the junction between the button portion and the casing.

### BACKGROUND OF THE INVENTION

1. Field of Invention

The invention relates to a casing and, in particular, to a casing with no penetrating interstice exists at the junction of the button portion and the casing

2. Related Art

As the electronic age coming, the demand and the dependence of the electronic products increase. For example, since the convenience of notebook is favored to all, notebooks are much more popular. In this consumer-oriented time, a good product not only has a competed price, but the character and convenience of the product are also the key reason for consumers to purchase or not. Therefore, manufacturers seriously investigate the products according to the demand of consumers.

Hereinafter, a notebook is used as an example. Please refer to FIG.1 and FIG. 2, the button structure 1 for a notebook includes a button portion 11, a connecting arm 12 and a fixing portion 13. The fixing portion 13 of the button structure 1 is connected to a casing 2 by the elastic connecting arm 12, wherein the fixing 13 is fixed on the casing 2 by way of fusing or by a screw (not shown in the figure).

Please refer to FIG. 2, when the button portion 11 is moved toward a first direction d1, an elastic counterforce makes the button portion 11 move toward a second direction d2 because the connecting arm 12 is elastic and the fixing portion 13 is fixed on the casing 2. The second direction d2 is opposite to the first direction d1. Moreover, the button structure 1 further includes a switching unit 14 disposed in the casing 2 under the button portion 11. The switching unit 14 includes a switch 141 and a circuit board 142. When the button portion 11 is moved toward the first direction d1, the button portion 11 contacts with the switch 141, and makes the switch 141 to establish a circuit connection of the circuit board 142.

Because the known button structure 1 and casing 2 are the different parts and are combined together by way of assembling, fabrication errors would occur during production, which lowers the production yield and increases production cost. Furthermore, a penetrating interstice 3 exists between the button structure 1 and casing 2 or among a plurality of the button structures 1 to prevent the buttons to be stuck. Dust and hair, however, are easily piled up in the interstice 3 and are hard to be cleaned.

As mentioned above, it is important to provide a button structure without interstices.

### SUMMARY OF THE INVENTION

In view of the above, the invention is to provide a casing for an electronic device having a button portion without penetrating interstices.

To achieve the above, the casing for an electronic device of the invention includes a button portion. The button portion is embedded in an opening of the casing with no penetrating interstices existing at the junction of the button portion and the casing.

In one aspect, the button portion may be embedded in the casing by double injection molding. The material of the casing may be a polymer material. The material of the button portion is different from the casing, and has greater elasticity than that of the material of the casing. The button portion may further have a groove to identify the position of the button.

Since no penetrating interstices exist at the junction of the button portion and the casing, the problems of fabrication errors and the piling up of dust and hairs can be avoided. The invention improves the production yield, and makes the cleaning of the casing easier.

### BRIEF DESCRIPTION OF THE DRAWINGS

The invention will become more fully understood from the detailed description given hereinbelow illustration only, and thus is not limitative of the present invention, and wherein:

FIG. 1 is a top view of the conventional button structure;

FIG. 2 is a cross sectional view of the conventional button structure along the A-A line;

FIG. 3 is a schematic diagram of the casing according to the preferred embodiment of the invention;

FIG. 4 is another schematic diagram of the casing according to the preferred embodiment of the invention;

FIG. 5 is a top view of the casing according to the preferred embodiment of the invention;

FIG. 6 is a top view of the electronic device according to the preferred embodiment of the invention; and

FIG. 7 is a cross sectional view of the electronic device according to the preferred embodiment of the invention along the A′-A′ line.

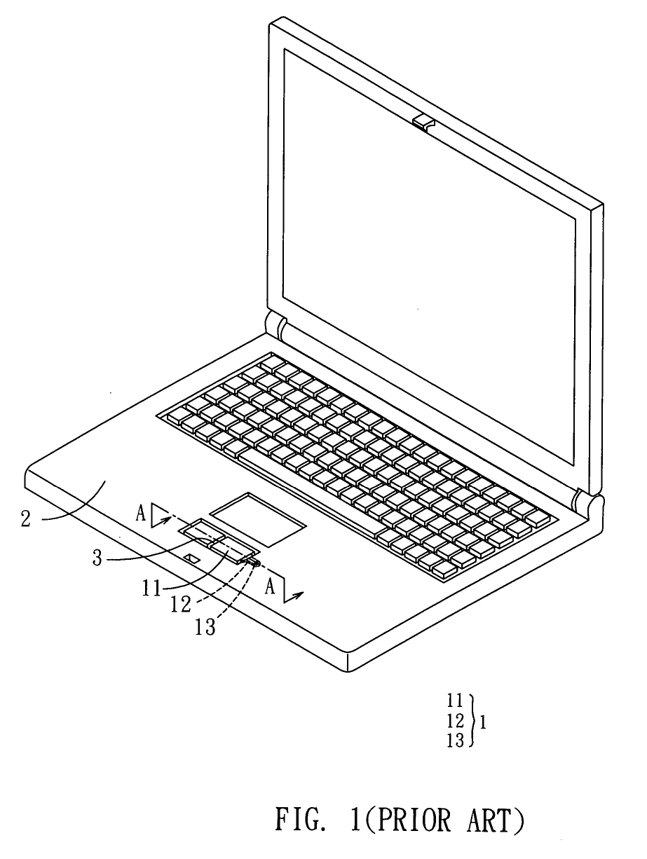

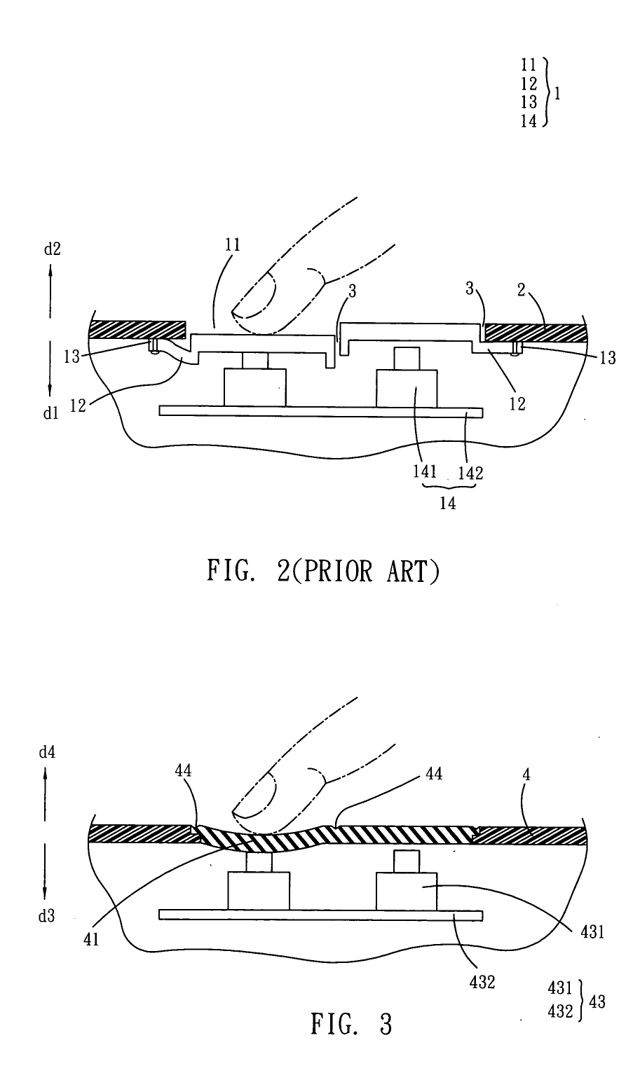

### DETAILED DESCRIPTION OF THE INVENTION

To make the invention more comprehensive, the casing for an electronic device according to the preferred embodiment of the invention will be described below using a notebook as an example with reference to relevant drawings, wherein the same reference number refer to the same element.

Referring to FIG. 3, a casing 4 for an electronic device according to the preferred embodiment of the invention includes a button portion 41. The button portion 41 is embedded in an opening of the casing 4, and there are no penetrating interstices existing at the junction of the button portion 41 and the casing 4. In the preferred embodiment, the button 41 is embedded in the casing 4 by way of double injection molding. It should be noted that any other method capable of making the button without any penetrating interstices existing at the junction of the button portion 41 and the casing 4 could be used.

In the embodiment, the materials of the button portion 41 and the casing 4 are different. The material of the button portion 41 is more elastic than the material of the casing 4. For example, the material of the casing 4 may be a polymer material, and the material of the button portion 41 may be rubber.

The electronic device includes a switching unit 43 corresponding to the button portion 41. The switching unit 42 includes a switch 431 and a circuit board 432. The switch 431 is disposed between the circuit board 432 and the button portion 41, and is connected to the circuit board 432. When the button portion 41 is forced to move toward a first direction d3, the button portion 41 contacts with and activates the switch 431. Because the rubber is elastic and the button portion 41 is embedded in the casing 4 with no penetrating interstices existing at the junction of the button portion 41 and the casing 4, when the force is released, an elastic counterforce makes the button portion 41 move toward a second direction d4. The first direction d3 is opposite to the second direction d4.

The button portion 41 has a groove 44 to separate each switch 431 and make it easier to figure out the position of the button portion 41. The grooves may also be provided between the button portion 41 and the casing 4. With the grooves, it is more convenient for users during operation.

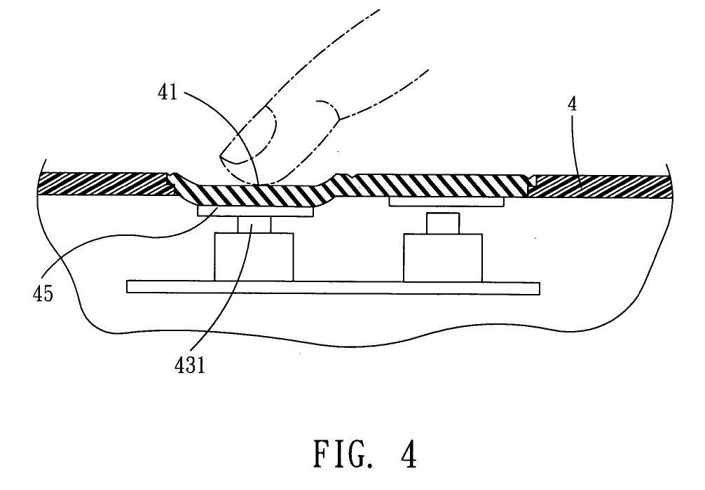

Since the button portion 41 is elastic and the area of the button portion 41 is substantially larger than the area of the top of the switch, the finger of a user might slide along the edge of the top of the switch 431 while pressing the button portion 41. This makes the pressing inaccurate, and causes problems while operating the electronic device. To solve this problem, with reference to FIG. 4, the casing 4 may further include a protrusion portion 45 facing the switch 431 and connecting to the button portion 41. The area of the protrusion portion 45 is larger than that of the top of the switch 431, and the material of the protrusion portion 45 is different from the material of the button portion 41. The material of the protrusion portion 45 is not elastic, so that it is easy to press the button portion 41 to make the protrusion portion 45 contact with the switch 431. Then, the switch 431 starts to establish the circuit connection of the circuit board 142.

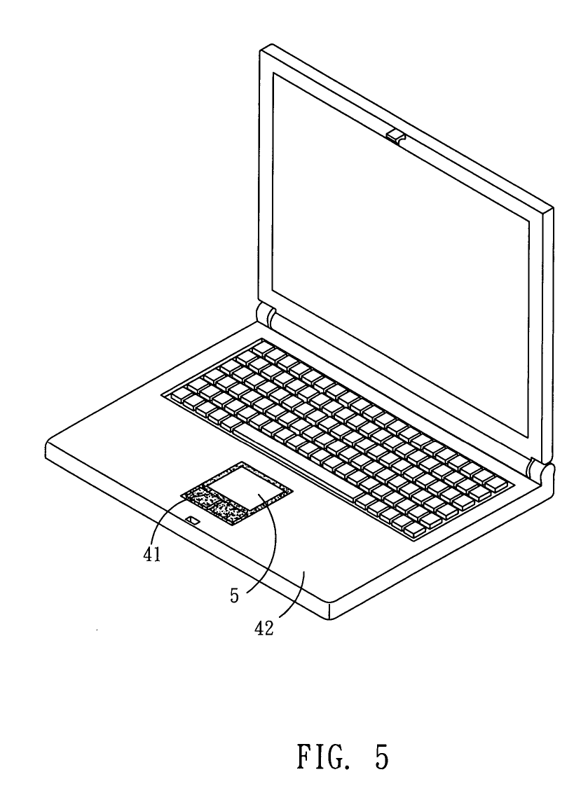

Please refer to FIG. 5. In another embodiment, the button portion 41 may extend to the area around the touch pad 5 to surround the touch pad 5. The material of the touch pad 5 is different from the button portion 41 and the casing 4

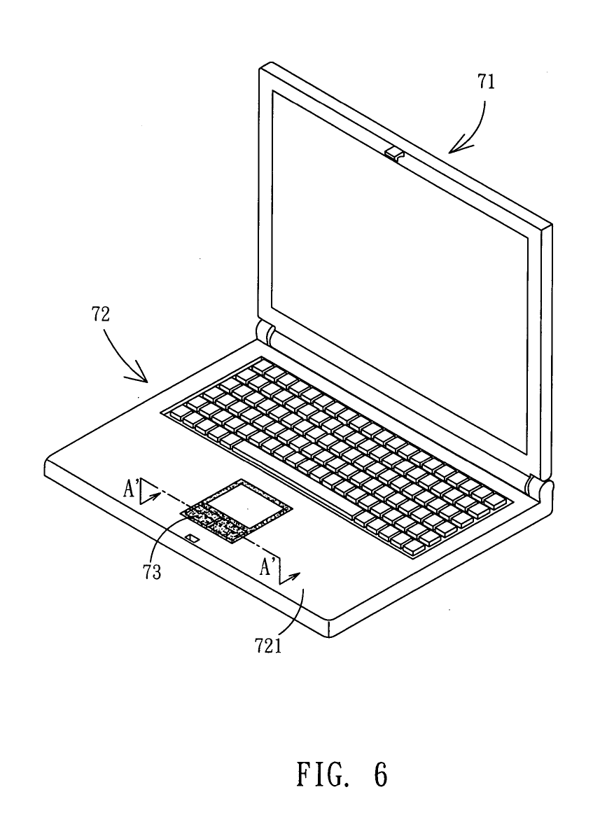

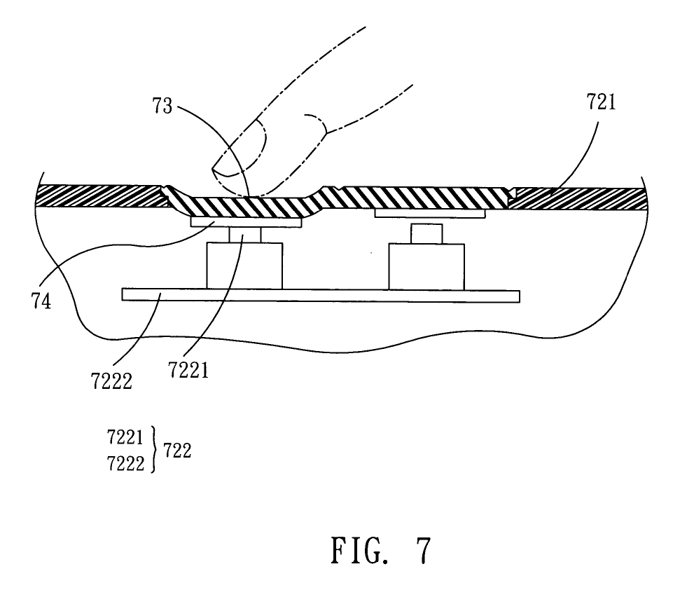

Please refer to FIG. 6 and FIG. 7. An electronic device 7 according to still another embodiment includes a display portion 71, an operating portion 72 and a button portion 73. The display portion 71 has a display. The operating portion 72 is connected to the display portion 71. The operating portion 72 includes a casing 721 with an opening and a switching unit 722 disposed inside the casing 721. The button portion 73 is embedded in the opening of the casing 721. The switching unit 722 faces to the button portion 73 with no penetrating interstices existing at the junction of the button portion 73 and the casing 721. The button portion 73 is embedded in the opening of the casing 721 byway of double injection molding.

The switching unit 722 includes a switch 7221 and a circuit board 7222. The switch 7221 is disposed on the circuit board 7222, and the button portion 73 is positioned on the switch 7221.

The electronic device 7 further includes a protrusion portion 74 facing to the switch 7221 and connecting to the button portion 73.

Since the structure, location and the function are the same as those mentioned in the previous embodiment, the relevant descriptions are omitted for concise purpose. In this embodiment, the button portion 73 is embedded in the opening of the casing 721, and there is no penetrating interstices existing at the junction of the button portion 73 and the casing 721, so that there is no problem of the poor fabrication and the piling up of dust and hairs. Therefore, the invention make the production yield higher and make the electronic device easier to clean.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A casing for an electronic device having a switching unit provided therein, the casing comprising:
a button portion embedded in an opening of the casing and corresponding to the position of the switching unit, wherein no penetrating interstice exists at the junction of the button portion and the casing.

2. The casing according to claim 1, wherein the button portion is embedded in the opening by double injection molding.

3. The casing according to claim 1, wherein the material of the casing is different from the material of the button portion.

4. The casing according to claim 1, wherein the elasticity of the button portion is larger than the elasticity of the casing.

5. The casing according to claim 1, wherein the material of the casing is macromolecular material and the material of the button portion is rubber.

6. The casing according to claim 1, wherein the button portion has a groove.

7. The casing according to claim 1, further comprising a protrusion portion connecting to the button portion and facing the switching unit.

8. An electronic device comprising:
a display portion;
a operating portion connected to the display portion, the operation portion including an casing having an opening and a switching unit provided inside the casing; and
a button portion embedded in an opening of the casing and corresponding to the position of the switching unit, wherein no penetrating interstice exists at the junction of the button portion and the casing.

9. The electronic device according to claim 8, wherein the button portion is embedded in the opening by double injection molding.

10. The electronic device according to claim 8, wherein the material of the casing is different from the material of the button portion.

11. The electronic device according to claim 8, wherein the elasticity of the button portion is larger than the elasticity of the casing.

12. The electronic device according to claim 8, wherein the material of the casing is macromolecular material and the material of the button portion is rubber.

13. The electronic device according to claim 8, wherein the button portion has a groove.

14. The electronic device according to claim 8, further comprising a protrusion portion connecting to the button portion and facing the switching unit.
